(19) United States
(12) Patent Application Publication
(10) Pub. No.: US 2009/0265246 A1
(43) Pub. Date: Oct. 22, 2009

(54) SYSTEM AND METHOD FOR CONNECTING USERS BASED ON EVENT PLANNING AND AVAILABLE VENUE SPACE

(76) Inventor: Heather Nelson, San Diego, CA (US)

Correspondence Address: CATALYST LAW GROUP, APC, 9710 SCRANTON ROAD, SUITE S-170, SAN DIEGO, CA, 92121, US

(21) Appl. No.: 12/249,765

(22) Filed: Oct. 10, 2008

Related U.S. Application Data
(60) Provisional application No. 60/978,911, filed on Oct. 10, 2007.

(51) Int. Cl. G06Q 30/00

(52) U.S. Cl. 705/14.73; 705/1; 705/27

(57) ABSTRACT

A process and system for connecting event organizers and venues on a neutral platform is disclosed and described herein. In an exemplary embodiment, organizers post an event with requirements, the events are listed, and venues review the list and express interest by responding with a profile. Organizers then select a venue from their responses and respond back with their contact information. Venues are further invited to contact the organizer outside the system and make necessary arrangements to formally secure a deal with an organizer. Preferred embodiments also include a main homepage having venue logos and advertising space. Further, venues and organizers each have a main homepage. A feedback user forum is also disclosed. Examples of events may include alumni mixers, birthdays, corporate events, holiday parties, networking events, rehearsal dinners, and the like.

### PRIORITY CLAIM

This patent application contains subject matter claiming benefit of the priority date of U.S. Provisional Patent Application Ser. No. 60/978,911 filed on Oct. 10, 2007, accordingly, the entire contents of this provisional patent application is hereby expressly incorporated by reference.

### BACKGROUND OF THE INVENTION

1. Field of the Invention

The present invention pertains generally to execution by a server system in a computer network including a plurality of user terminals connecting event planners to venue sales managers. More specifically, the present invention relates to a neutral on-line portal connecting organizers of private and corporate events to venue managers looking to maximize rental of their establishments. The present invention is particularly, but not exclusively, useful as a system and method allowing event organizers to post on a website the specific details of a projected event; and the website also allowing venues to compete for their business by purchasing a subscription of a certain term length that allows them to express interest in specific posted events so that the organizers can reply back to those interested venues with their contact information, in order to secure placement of a venue for their event.

2. Description of the Prior Art

Recently and in history, entrepreneurs have developed successful businesses based on providing the means with which to connect people and entities that need one another. In doing so, the connecting agents provide users with efficiency and minimize the cost of lost opportunities. Examples of such agents may include real estate brokers, employment agencies and on-line dating services.

Accordingly, there is a strong need for a neutral, transparent, uninterested platform where organizers of group events, especially those with little or no budget, can find venues willing to work within their means and limitations and then venues can also have a direct lead to those groups looking for a place to hold their gathering and increase their opportunity to raise additional revenue that would otherwise expire at the end of each day. Currently in the market for conducting events, organizers that are looking for a venue, and additionally those that are reluctant to reach out to venues at all. are often discouraged by the typical venue that insists out-of budget food and beverage minimums be guaranteed in contract to secure placement in their establishment. This forces the organizers to work with the venues' requirements. In turn. venues are missing out on the chance to generate revenue from event attendees that will usually purchase food and beverages on site when those costs are not able to be absorbed by their event's organizer. With an innovative system and method, those organizers with larger budgets could also benefit from venues competing for their business and allow the organizer to leverage what they are willing to spend for what they can get in return.

In light of the above, it is an object of the present invention to provide a system and method assisting connection in a relatively unconnected market. It is further an object of the present invention to provide an on-line portal assisting organizers in their search for an appropriate venue while having specific budgets and other specifications. It is still further an object of the present invention to provide a system and method of connecting event organizers and venue sales managers that is convenient and easy to use.

### BRIEF SUMMARY OF THE INVENTION

The present invention specifically addresses and alleviates the above mentioned deficiencies, more specifically, the present invention is directed to an electronic matching and information exchange method for event planners and venue managers on a telecommunications network, the method comprising: providing a centralized homepage to a plurality of users; posting by an event planner an event having event details via the centralized homepage; responding to posting by a first venue manager, the event manager responding on behalf of a venue having a venue profile; and selecting by the event planner from the responding based on the event details substantially met by the venue profile.

The first method of matching and information exchange herein further comprises repeating the responding by second and subsequent venue managers; viewing a list of venue responses by the event planner; and comparing the venue profiles of each of the venue responses.

In preferred embodiments herein the event details comprise: an event date; an event type; an estimate of the number of people; and a preferred geographic location. Additionally, the method of matching and information exchange further comprises providing a first venue logo to the centralized homepage; linking the first venue logo to a corresponding venue profile; and rotating second and subsequent logos and sharing an advertising space on the homepage.

The preferred method further comprises offering a paid subscription to the venue managers. Additionally the method includes providing feedback between event organizers and venue managers; and displaying the feedback for a benefit to other users. In an exemplary embodiment, a venue profile comprises: a venue type; a venue address; a venue description; and a website address.

The method of matching and information exchange still further comprises providing an organizer main account homepage; providing a venue main account homepage; and updating the venue profile via the venue main account homepage. As an example, an event is chosen from a group consisting of alumni mixer anniversary celebration, bachelor/bachelorette, bar/bat mitzvah, quinceanera, birthday, debutante ball, charity event, cocktail reception, comedy show, conference, convention, corporate, engagement party, farewell party, fashion show, graduation celebration, happy hour, holiday party, karaoke, meeting, networking, night on the town, office outing, personal/social, product launch, rehearsal dinner, retirement party, singles event, social gathering, team building, wine event, or music conceit.

In another embodiment, the invention may be characterized as an electronic matching and information exchange method for a plurality of event planners and a plurality of venue managers on a telecommunications network, the method comprising: providing a venue homepage to the venue managers; providing an event planner homepage to the event planners; posting by a first event planner of the plurality of event planners an event having event details via the event planner homepage; responding to posting by a first venue manager via the venue manager homepage, the event manager responding on behalf of a venue having a venue profile; repeating the responding by second and subsequent venue managers; viewing a list of venue responses by the event planner; comparing the venue profiles of each of the venue responses; and selecting by the event planner from the responding based on the event details substantially met by the venue profile.

This method additionally comprises viewing by the first, second and subsequent venue managers the posting by the first event planner; charging a subscription service for the responding and the repeating the responding by the first, second and subsequent venue managers; and repeating the posting by second and subsequent event planners.

The present invention can additionally be characterized as a system for connecting a plurality of event planners and a plurality of venue managers comprising: a telecommunications network; and a centralized website accessible via the telecommunications network, the centralized website further comprising: a list of a plurality of events each having a plurality of event details, each of the plurality of events corresponding to one or more of the plurality of event planners; a link accessible to the venue managers connecting the venue managers to one or more of the event planners with one or more venue responses; and an event planner inbox having the one or more venue response.

In a preferred embodiment, the system herein can be additionally characterized in that the centralized website further comprises an organizer response list having the one or more event planner responses, and a venue inbox providing access to the organizer response list. Also it comprises one or more venue logos; and one or more links to one or more venue websites.

The system for connecting a plurality of event planners and a plurality of venue managers, the plurality of event details comprising: an event date; an event type; an estimate of the number of people; and a preferred geographic location.

The system for connecting a plurality of event planners and a plurality venue manager further comprises a plurality of venue registrations, the plurality of venue registrations comprising: a company name; a company address; a phone number-; an attendance capacity; and a website address. Further, the invention is characterized wherein the link accessible to the venue managers comprises an express interest button.

While the apparatus and method has or will be described for the sake of grammatical fluidity with functional explanations, it is to be expressly understood that the claims, unless expressly formulated under 35 USC 112, or similar applicable law, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112, or similar applicable law. The invention can be better visualized by turning now to the following drawings wherein like elements are referenced by like numerals.

### BRIEF DESCRIPTION OF THE DRAWINGS

The novel features of this invention, as well as the invention itself both as to its structure and its operation, will be best understood from the accompanying drawings, taken in conjunction with the accompanying description, in which similar reference characters refer to similar parts, and in which:

FIG. 1A is a functional block diagram of event organizer actions according to a preferred embodiment of the present invention;

FIG. 1B is a functional block diagram of venue sales manager actions according to a preferred embodiment of the present invention; and

FIG. 2 is a still another functional block diagram illustration an on-line portal of the present invention.

### DETAILED DESCRIPTION OF THE PREFERRED EMBODIMENTS

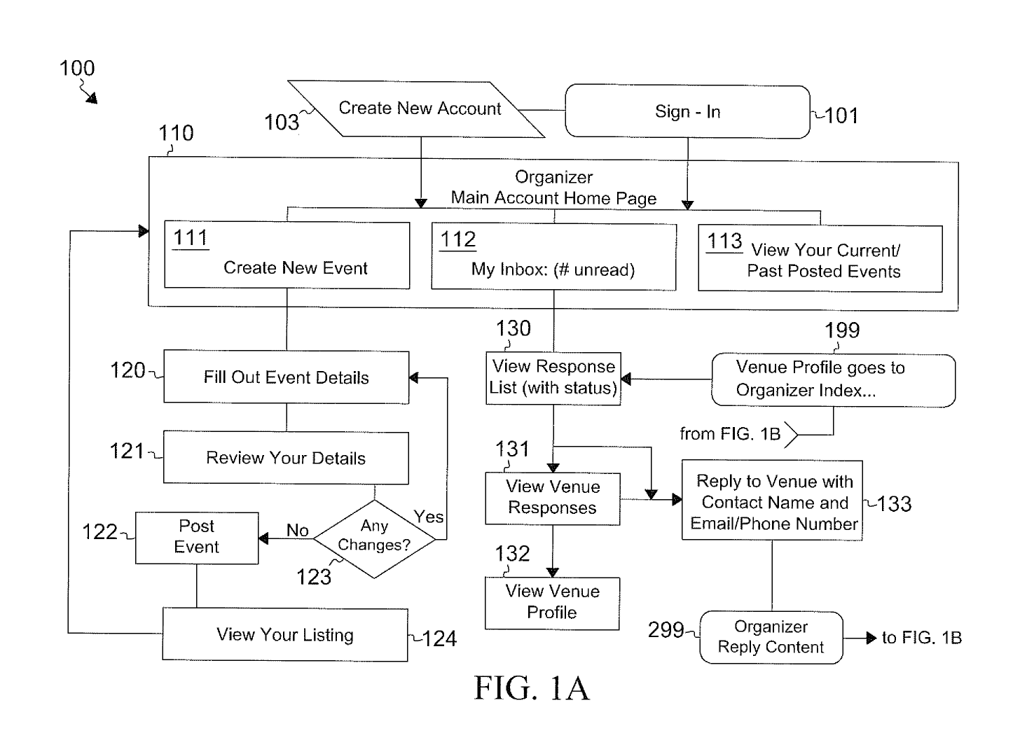

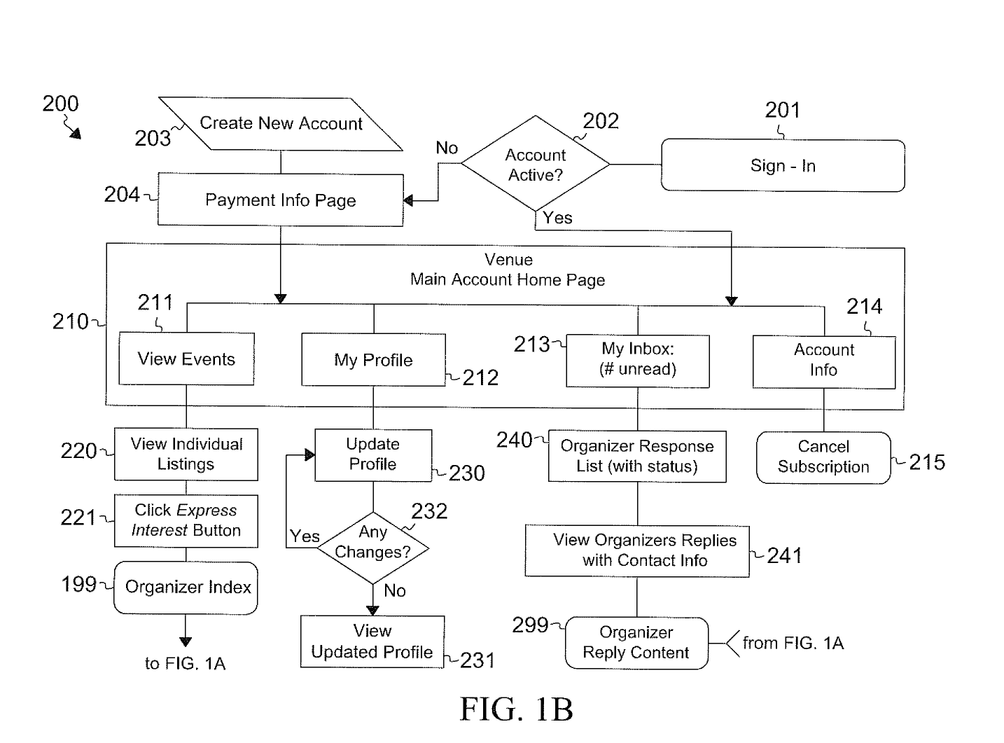

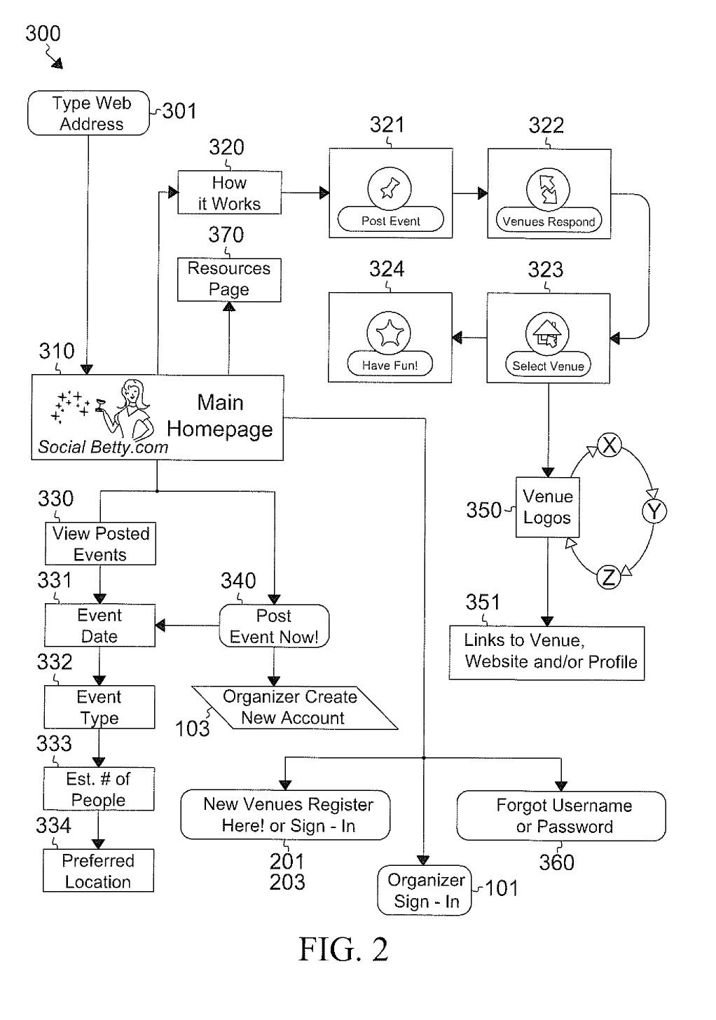

With reference initially to FIG. 1A (and FIG. 2), organizers 100 (such as lay individuals and professional event planners) will post 120, 121, 122, 321, 340 specific details 331-334 of a projected gathering of people (e.g. a birthday party, networking event, music public performance or alumni mixer) with the purpose of accessing venue space where they can accommodate their gathering. With reference FIG. 1B, venues 200 (e.g. restaurants, bars, nightclubs) will initiate contact 221, 322 with organizers 100 based on identified potential ability to host specific gatherings at their establishment. Various methods and systems for connecting organizers and venues are disclosed and claimed herein. An exemplary method includes: (1) organizers post 122, 321, 340 their event details 331-334 (e.g. date, time 331, estimated number of people 333); (2) venues search 330 a list of postings 211 and identify 220 potential gatherings to accommodate; (3) venues notify 221, 322 organizers, within the system, of their interest; (4) organizers choose 131, 323, from received 130, 322 venue options and make contact 133 with reply content 299; and lastly (5) have fun! In a preferred embodiment 300, an icon for posting event 321 is a thumbtack; an icon for a venue response 322 is two directional arrows; an icon for select venue 323 is a house with an arrow; and a “have fun” 324 icon is a star.

The disclosed embodiments provide lay and professional event organizers with access to venue options in a manner that will likely reduce requirements of initial deposits and high or out of budget food and beverage minimums and, in turn, will allow venues 200 to fill their space that would otherwise have not have been booked (especially during non-peak times) representing an unrealized opportunity. Still further, the system and methods of the present invention provide a fundamental shift in the way events are planned and venues procured. Traditionally, it was up to the event planners to initiate contact with the venues which may involve a large amount of investigation. Conversely the present invention gives organizers leverage having perhaps several venues initiate contact 221, 322 with them based on the posting 122, 321, 340. Accordingly, from the organizer point of view the leverage power in negotiation has shifted to them.

The methods described herein can be implemented, for example, in a computer network or a website 300 comprising various webpages upon typing an identifying web address 301. importantly, the user-friendliness of the website 300 will allow organizers 100 to save time in finding venues that fit their gathering needs and will likely encourage lay individuals to book gatherings at venues that they would not have otherwise considered. Organizers 100 will be required to pre-determine if interested venues 200 are a good fit for their gathering and do all necessary follow-up with venues to make sure venue space needed is formally secured (typically in a written contract). Venues 200 will likely make less money from usual food, beverage, and deposit minimums, but will likely generate more revenue off of food and beverages purchased by guests and organizers 100 that would not have otherwise occupied their establishment. The disclosed embodiments thus assists venues 200 in filling otherwise vacant establishment space in a manner that stimulates latent and unfulfilled demand from lay and professional organizers' 100 need for gathering space. Further as an option, venues 200 will pay a subscription fee for this service and have the opportunity to pay for premium listing with organizers. From a venue main account homepage 210, venues can access account information 214 and cancel subscription 215.

Additionally, venues could pay the service of present invention for logo display 350 and/or a link 351 to a venue's website. Yet further in a preferred embodiment. venue logos “X,” “Y,” and “Z” rotate through, and share exposure on a particular portion of the main home page 310.

For quality control measures, organizers 100 and venues 200 will have the opportunity to rate one another on their interaction with each other and the cumulative results will be displayed. In a preferred embodiment, organizers 100 will have the ability to send electronic invitations to their guests. A “forgot username or password” procedure 360 is additionally provided. Also importantly, a resources page 370 is strengthening the connecting provided by the present invention. The resources page 370 is particularly useful as an information and connection portal for event planners with categories including but not limited to: bartending, beverage suppliers, cake and dessert designers, caterers and staffing, entertainment services, event rental companies, event & meeting organizations, event lighting/audio/visual, event planning companies, event marketing & design, florists, industry magazines, industry production companies, industry promotion companies, industry websites, limousine/transportation services, musicians: networking organizations, novelty items, photographers, venue reviews, videographers, and wedding planning. Further, resources page 370 allows for users of the present invention to generate revenue and partnerships with vendors of these services.

In a preferred embodiment, a system 100, 200, 300 of the present invention includes a computer network that includes a graphical user interface, a network server, database, and a plurality of users known as either organizers 100 or venues 200. Initially, users register 103, 203 and provide related information that will be stored. This information can include username or ID, password, and related personal/business profile.

A preferred main website homepage 310 will primarily cater to organizers 100, and venues 200 will have a small area that links them to a section of the website more catered to them. The main website homepage 310 is first accessed 301 and allows for account login 101, 201 (both organizers and venues) and will provide links to related information, including “How it Works 320,” “Why Use Social Betty,” “Tips!,” “Success Stories,” etc. The section of the website more catered to venues 200 will include information related to their needs and subscription prices.

In an exemplary embodiment, organizers 100 can view their main account homepage 110 upon signing in 101. Options on the organizer homepage 110 include creating a new event 111, checking an inbox 112 to view responses 131, or view current and past posted events 113, 321. In creating a new event 111, organizers 100 can view their own listing 124 and make changes 123 thereto.

Once an organizer 100 has become a registered 103 user, they can input 120 and post 122, 340 their projected details of an anticipated event. This information can include geographic area 334, date, time (start and end) 331, estimated number of people 333, event type 332 (including, but not limited to: alumni mixer, anniversary celebration, bachelor/bachelorette, bar/bat mitzvah, quinceanera, birthday, debutante ball, charity event, cocktail reception, comedy show, conference, convention, corporate, engagement party, farewell party, fashion show, graduation celebration, happy hour, holiday party, karaoke, meeting, networking, night on the town, office outing, personal/social, product launch, rehearsal dinner, retirement party, singles event, social gathering, team building, wine event, music concert and other venue type (including, but not limited to: restaurant, bar/lounge, nightclub, hotel, amusement/theme destination), space preferences (including, but not limited to: general venue access, designated area, semi-private area, private area), food budget (including, but not limited to: no food, cash food, hosted light appetizers, hosted heavy appetizers, hosted menu options), bar budget (for example, no bar, cash bar, hosted beer/wine, hosted beer/wine/spirits), age related questions (for example all ages, 18 and up, 21 and over), and any special requests (for example, reception table) or specific details.

Once a venue 200 has become a registered 203 user, they will have the ability to read event postings 211 from their main account home page 210. In one preferred embodiment, venues are offered to purchase a subscription 204 that will enable them to reply 221 to organizers in an attempt to show interest and make contact. Further, venues' replies 221 will post in the organizers' accounts 199. Additionally, venues' replies will include information 212 about their establishment. This information 212 can include company name, address, phone number, capacity, and website address and may be updated 230 and viewed 231 at any time according to the venue main account homepage 210.

In a separate preferred embodiment, a venue can become a registered user in that profile information may be stored with the system 200, however they will not be permitted to access the venue main account homepage 210 until a subscription is paid.

In still another exemplary embodiment, venue shall complete a venue profile 212 that may be used in a variety of ways including various links thereto 212 from various locations of the system and method 100, 200, 300. The venue profile 212 may also be included within the text of a venue response 199. Additionally, from the venue main account homepage 210, venue profiles 212 may be updated 230 with changes made 232 and further updates viewed 231.

Further to a venue homepage 210, if a subscription has lapsed 202 then the user is directed to the payment information page 204. Also on the homepage 210, venue managers can check an inbox 213 and view organizers replies with contact information 241 via a general organizer response list 240 with response status. It is additionally important to note that anyone is able to view event postings even without a subscription according to a preferred embodiment. This will allow unsubscribed venues to see how others are using the system and methods of the invention and act as an enticer for venues to be part of the service. A paid subscription however is required to respond to a particular posting.

As venue profiles are arranged in an organizer index 199, organizers 100 can view responses 131 and profiles 132 are afforded discretion to choose 133 to respond and send their contact information back to the venues that have replied 221 to their posting 122. Organizers and venues can then independently make contact, negotiate details, and finalize arrangements. The preferred website 310 will provide links to information pages that will help facilitate the entire process of securing a venue for an event.

It is still further important to note that the present invention provides a measure of transparency as a neutral platform providing means for event planner-s and venues to connect but not doing more to broker a deal and act as a middle man. In other words, the uninterested platform 100, 200, 300 of the present invention allows venues and organizers to directly interact. Another aspect of the transparency is that the public can see the list of events 330 without having to perform any tasks such as registering information, thereby attracting the attention of both venues and event planners.

Both organizers and venues will are able to provide feedback based on their experience working together. The results of this feedback will be displayed with the intent for quality control in that both organizers and venues will be able to use each others' feedback results to determine their own interest in working with one another.

Further preferred embodiments provide that organizers have the ability to send electronic invitations to their guests. This will include a system that enables organizers to electronically send their event information to their invitees. Additionally, display and text space will be made available throughout the system for advertising 350. Still further, banner advertisements shall be a portion of an important monetizing model of the present invention.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

While the particular System and Method Connecting Users Based on Event Planning And Available Venue Space as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed in:

1. An electronic matching and information exchange method for event planners and venue managers on a telecommunications network, the method comprising:
providing a centralized homepage to a plurality of users;
posting by an event planner an event having event details via the centralized homepage;
responding to posting by a first venue manager, the event manager responding on behalf of a venue having a venue profile; and
selecting by the event planner from the responding based on the event details substantially met by the venue profile.

2. The method of matching and information exchange of claim 1 further comprising:
repeating the responding by second and subsequent venue managers;
viewing a list of venue responses by the event planner; and
comparing the venue profiles of each of the venue responses.

3. The method of matching and information exchange of claim 1, the event details comprising:
an event date;
an event type;
an estimate of the number of people; and
a preferred geographic location.

4. The method of matching and information exchange of claim 1 further comprising:
providing a first venue logo to the centralized homepage;
linking the first venue logo to a corresponding venue profile; and
rotating second and subsequent logos and sharing an advertising space on the homepage.

5. The method of matching and information exchange of claim 1 further comprising offering a paid subscription to the venue managers.

6. The method of matching and information exchange of claim 1 further comprising:
providing feedback between event organizers and venue managers; and
displaying the feedback for a benefit to other users.

7. The method of matching and information exchange of claim 3, wherein a venue profile comprises:
a venue type;
a venue address;
a venue description; and
a website address.

8. The method of matching and information exchange of claim 3, the method further comprising:
providing an organizer main account homepage;
providing a venue main account homepage; and
updating the venue profile via the venue main account homepage.

9. The method of matching and information exchange of claim 1, wherein the event is chosen from a group consisting of alumnii mixer, anniversary celebration, bachelor/bachelorette, bar/bat mitzvah, quinceanera, birthday, debutante ball, charity event, cocktail reception, comedy show, conference, convention, corporate, engagement party, farewell party, fashion show, graduation celebration, happy hour, holiday party, karaoke, meeting, networking, night on the town, office outing, personal/social, product launch, rehearsal dinner, retirement party, singles event, social gathering, team building, wine event, wedding, or music concert.

10. An electronic matching and information exchange method for a plurality of event planners and a plurality of venue managers on a telecommunications network, the method comprising:
providing a venue homepage to the venue managers;
providing an event planner homepage to the event planners;
posting by a first event planner of the plurality of event planners an event having event details via the event planner homepage;
responding to posting by a first venue manager via the venue manager homepage, the event manager responding on behalf of a venue having a venue profile;
repeating the responding by second and subsequent venue managers;
viewing a list of venue responses by the event planner:
comparing the venue profiles of each of the venue responses; and
selecting by the event planner from the responding based on the event details substantially met by the venue profile.

11. The method of matching and information exchange of claim 10, further comprising
viewing by the first, second and subsequent venue managers the posting by the first event planner;
charging a subscription service for the responding and the repeating the responding by the first, second and subsequent venue managers; and
repeating the posting by second and subsequent event planners.

12. The method of matching and information exchange of claim 10, further comprising;
providing a resource page for event planners wherein the resource page comprises bartending, beverage suppliers, cake and dessert designers, caterers and staffing, entertainment services, event rental companies, event & meeting organizations, event lighting/audio/visual, event planning companies, event marketing & design, florists, industry magazines, industry production companies, industry promotion companies, industry websites, limousine/transportation services, musicians, networking organizations, novelty items, photographers, venue reviews, videographers, and wedding planning.

13. A system for connecting a plurality of event planners and a plurality of venue managers comprising:
a telecommunications network; and
a centralized website accessible via the telecommunications network, the centralized website further comprising:
a list of a plurality of events each having a plurality of event details, each of the plurality of events corresponding to one or more of the plurality of event planners;
a link accessible to the venue managers connecting the venue managers to one or more of the event planners with one or more venue responses; and
an event planner inbox having the one or more venue response.

14. A system for connecting a plurality of event planners and a plurality of venue managers of claim 13, the centralized website further comprising:
an organizer response list having the one or more event planner responses; and
a venue inbox providing access to the organizer response list.

15. A system for connecting a plurality of event planners and a plurality of venue managers of claim 13, the centralized website further comprising:
one or more venue logos; and
one or more links to one or more venue websites.

16. A system for connecting a plurality of event planners and a plurality of venue managers of claim 13, the plurality of event details comprising:
an event date;
an event type;
an estimate of the number of people; and
a preferred geographic location.

17. A system for connecting a plurality of event planners and a plurality of venue managers of claim 13, further comprising a plurality of venue registrations, the plurality of venue registrations comprising:
a company name;
a company address;
a phone number;
an attendance capacity; and
a website address.

18. A system for connecting a plurality of event planners and a plurality of venue managers wherein the link accessible to the venue managers comprises an express interest button.
